(19) United States
(12) Patent Application Publication
(10) Pub. No.: US 2022/0144435 A1
(43) Pub. Date: May 12, 2022

(54) SYSTEMS AND METHODS FOR LIFTING AN OBJECT

(71) Applicant: SIGNIFY HOLDING B.V., EINDHOVEN (NL)

(72) Inventors: Vincent Stefan David GIELEN, GASTEL (NL); Maurice Herman Johan DRAAIJER, ITTERVOORT (NL); Wei Pien LEE, EINDHOVEN (NL); Harry BROERS, 's-HERTOGENBOSCH (NL); Jan EKKEL, OSS (NL)

(21) Appl. No.: 17/440,857

(22) PCT Filed: Apr. 2, 2020
(86) PCT No.: PCT/EP2020/059391

§ 371 Date: Sep. 20, 2021

(30) Foreign Application Priority Data
Apr. 5, 2019 (EP) 19167491.0

(51) Int. Cl. B64D 1/22; B64C 39/02

(52) U.S. Cl. CPC B64D 1/22; B64C 39/024; B64C 2201/128; B64C 2201/108; B64C 2201/027

(57) ABSTRACT

A system and method for operating a lift mechanism are provide, the lifting mechanism (100, 200) including a first housing component (102, 202) and a second housing component (104, 204), the second housing component including a plurality of legs (132, 232) arranged to stabilize the lifting mechanism against a surface of an object, and a magnet (134, 234) arranged within the second housing component. The lifting mechanism further includes a first coupling shaft (136, 236) arranged between the first housing component and the second housing component the first coupling shaft arranged to allow for two degrees of rotational freedom of the first housing component with respect to the second housing component.

### FIELD OF THE DISCLOSURE

The present disclosure is directed generally to lifting mechanisms, specifically to lifting mechanisms arranged to engage with an Unmanned Aerial Vehicle (UAV).

### BACKGROUND

Luminaires for street lamps and other lighting fixtures are typically mounted atop a pole or post making it difficult to install, replace, or maintain luminaires after the pole or post is mounted upright. Currently, street lamps require manual installation methods to screw or affix the luminaire or lamp to an installed light pole resulting in decreased efficiency.

### SUMMARY OF THE DISCLOSURE

The present disclosure is related to systems and methods for installation, removal, and/or servicing of a luminaire or lamp utilizing a lifting mechanism arranged between a UAV and the luminaire or lamp where the lifting mechanism allows for increased stability of the takeoff and landing of the UAV when the luminaire or lamp is being lifted, as well as, increased flight stability by allowing at least two degrees of rotational freedom of the luminaire or lamp with respect to the UAV.

In one aspect, a lifting mechanism is provided, the lift mechanism including a first housing component and a second housing component, the second housing component including a plurality of legs arranged to stabilize the lifting mechanism against a surface of an object, and a magnet arranged within the second housing component. The lifting mechanism further includes a first coupling shaft arranged between the first housing component and the second housing component the first coupling shaft arranged to allow for two degrees of rotational freedom of the first housing component with respect to the second housing component.

In an aspect, the first housing component further comprises a first end, a second end, and a first through-bore arranged between the first end and the second end and the second housing component further includes a third end, a fourth end, and a second through-bore arranged between the third end and the fourth end.

In an aspect, the first coupling shaft includes a first shaft and a second shaft coupled via a first joint.

In an aspect, the first housing component further includes a first interface aperture arranged to accept a first interface fastener, the first interface fastener arranged to engage with the first shaft of the first coupling shaft and slidingly engage with the first interface aperture.

In an aspect, the second housing component further including a second interface aperture arranged proximate the third end of the second housing component and arranged to receive a second interface fastener, the second interface fastener arranged to fixedly secure the second housing component to the second shaft of the first coupling shaft. In an aspect, the fourth end of the second housing component comprises a primary alignment feature arranged to engage with an object alignment feature on the object.

In an aspect, a first slide member is arranged within the second through-bore and operatively engaged with the second shaft of the first coupling shaft.

In an aspect, the lifting mechanism further includes a third housing component having a fifth end, a sixth end, and a third through-bore arranged between the fifth end and the sixth end and a second coupling shaft arranged between the first housing component and the second housing component and arranged to allow arranged to allow for two degrees of rotational freedom of the first housing component with respect to the third housing component, where the second coupling shaft further comprises a third shaft, a fourth shaft, and a second joint.

In an aspect, the first housing component further comprises a first interface aperture arranged to accept a first interface fastener, the first interface fastener arranged to engage with the first shaft of the coupling shaft and slidingly engage with the first interface aperture and the third housing component further includes a second interface aperture arranged proximate the fifth end of the third housing component and arranged to receive a second interface fastener, the second interface fastener arranged to fixedly secure the third housing component to the second shaft of the first coupling shaft.

In an aspect, the third housing component further includes a third interface aperture arranged to accept a third interface fastener, the third interface fastener arranged to engage with the third shaft of the second coupling shaft and fixedly secure the sixth end of the third housing component to the third shaft of the second coupling shaft, and the second housing component further comprises a fourth interface aperture arranged to accept a fourth interface fastener, the fourth interface fastener arranged to engage with the fourth shaft of the second coupling shaft and fixedly secure the third end of the second housing component to the fourth shaft of the second coupling shaft.

In an aspect, the lifting mechanism further includes a first slide member arranged within the third through-bore and operatively engaged with the second shaft of the first coupling shaft, and a second slide member arranged within the third through-bore and operatively arranged to engage with the third shaft of the second coupling shaft.

In an aspect, the third through-bore of the third housing component further includes a first partition, wherein the first partition is secured to the third shaft of the second coupling shaft via a first resilient element.

In an aspect, the first end of the first housing component comprises a first engagement plate arranged to fixedly secure the first housing component to an Unmanned Aerial Vehicle (UAV).

In an aspect, a method of lifting an object using an Unmanned Aerial Vehicle (UAV) is provided, the method including: coupling a lifting mechanism to the UAV; positioning the UAV above an object in a first direction; lowering the UAV in a second direction opposite the first direction toward the object; energizing a magnet located on the lifting mechanism such that the magnet magnetically couples the lifting mechanism to the object; driving the UAV in the first direction, where during operation the lifting mechanism is arranged to have two degrees of rotational freedom about a first coupling shaft integrated within the lifting mechanism.

In an aspect, during the operation of the lifting mechanism the lifting mechanism is arranged to transition from a locked position to an unlocked position, where the lifting mechanism is in the unlocked position during a first motion of the UAV. These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a perspective view of a lifting system according to the present disclosure.

FIG. 2A is a front elevational view of a lifting mechanism in a locked state according to the present disclosure.

FIG. 2B is a front elevational view of a lifting mechanism in an unlocked state according to the present disclosure.

FIG. 3A is cross-sectional view of a lifting mechanism according to the present disclosure.

FIG. 3B is a bottom perspective view of a lifting mechanism according to the present disclosure.

FIG. 3C is a detail perspective view of a lifting mechanism according to the present disclosure.

FIG. 3D is a bottom perspective view of a lifting mechanism according to the present disclosure.

FIG. 4 is a detail view of a first coupling shaft of a lifting mechanism according to the present disclosure.

FIG. 5 is a top perspective schematic view of UAV according to the present disclosure.

FIG. 6 is a front elevational schematic view of a lifting mechanism according to the present disclosure.

FIG. 7A is a schematic view of a lifting mechanism in a locked state according to the present disclosure.

FIG. 7B is a schematic view of a lifting mechanism in an unlocked state according to the present disclosure.

FIG. 7C is a schematic view of a lifting mechanism in an unlocked state according to the present disclosure.

FIG. 8A is a schematic view of a lifting mechanism in a locked state according to the present disclosure.

FIG. 8B is a schematic view of a lifting mechanism in an unlocked state according to the present disclosure.

FIG. 9A is a schematic view of a lifting mechanism in an unlocked state according to the present disclosure.

FIG. 9B is a schematic view of a lifting mechanism in an unlocked state according to the present disclosure.

FIG. 10 is a flow chart illustrated the steps of a method according to the present disclosure.

### DETAILED DESCRIPTION OF EMBODIMENTS

The present disclosure describes systems and methods for installation, removal, and/or servicing of a luminaire or lamp utilizing a lifting mechanism arranged between a UAV and the luminaire or lamp where the lifting mechanism allows for increased stability of the takeoff and landing of the UAV when the luminaire or lamp is being lifted, as well as, increased flight stability by allowing at least two degrees of rotational freedom of the luminaire or lamp with respect to the UAV.

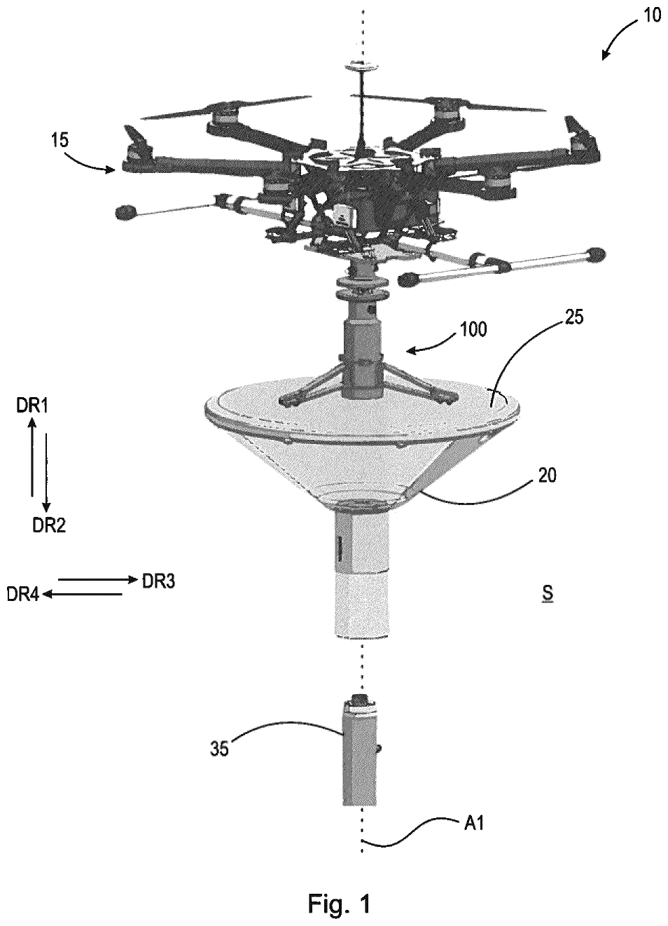

Referring to the figures, FIG. 1 is a perspective view of lifting system 10 according to the present disclosure. Lifting system 10 generally includes an Unmanned Aerial Vehicle (UAV) 15 and lifting mechanism 100 arranged to engage with the UAV 15 and an object 20 arranged to be installed on a post 35. UAV 15 is intended to be a motorized, remote controlled, flying vehicle, for example, a drone, having enough lift force, i.e., force in a first direction DR1 orthogonal to the surface of the ground in which post 35 is installed, to lift the combined weight of lifting mechanism 100 and object 20. It should be appreciated that, although described and illustrated in the figures as a remote control drone, any device capable of sustained flight having enough lift force to lift lifting mechanism 100 and object 20 can be utilized.

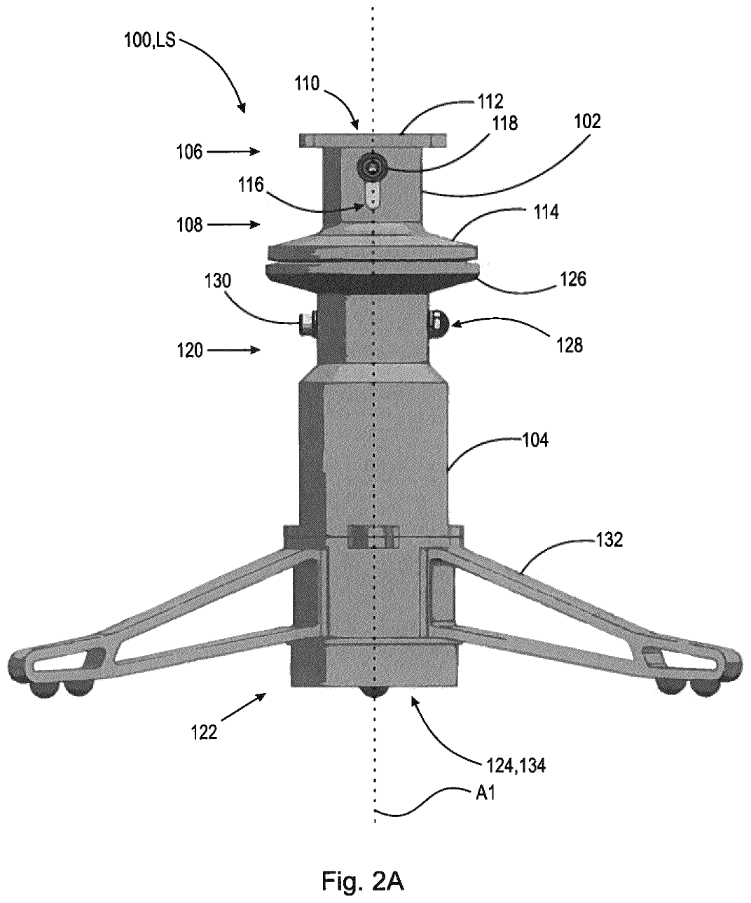

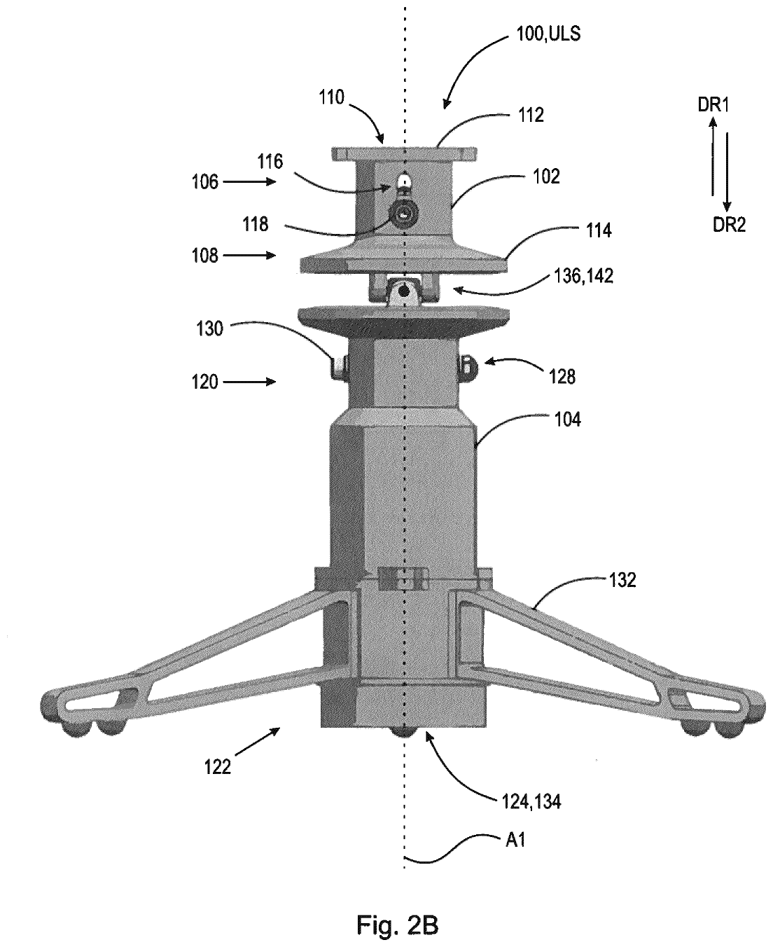

Object 20, in addition to being arranged to engage with post 35, is also arranged to engage with lifting mechanism 100 via a first surface 25. For example, object 20 can be a luminaire, lamp, or other powered light source capable of being secured to post 35 to provide illumination to a space S. First surface 25 is arranged to engage with a plurality of legs, e.g. first plurality of legs 132 (shown in FIG. 2A) of lifting mechanism 100, described below. Moreover, first surface 25 can also include an object alignment feature 30. Although, not illustrated, object alignment feature 30 (not shown) is intended to be a cylindrical projection extending in first direction DR1 from first surface 25 of object 20, having a diameter that is smaller than, for example, the diameter of primary alignment feature 144 of lifting mechanism 100 discussed below. Additionally, object alignment feature 30 is intended to be selected from a ferrous metal material, i.e., able to interact or respond to a magnetic field.

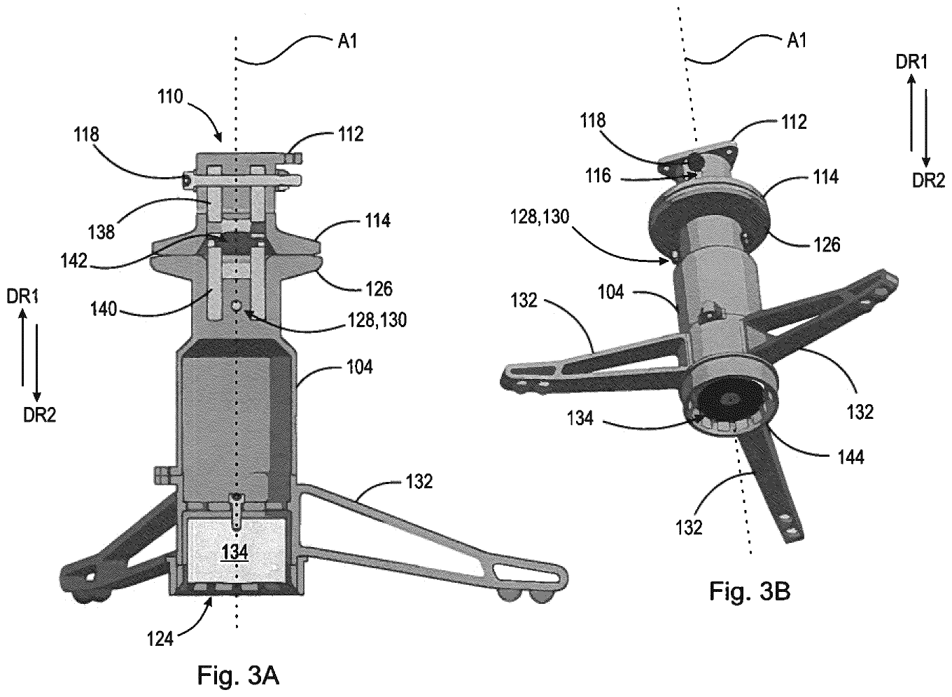

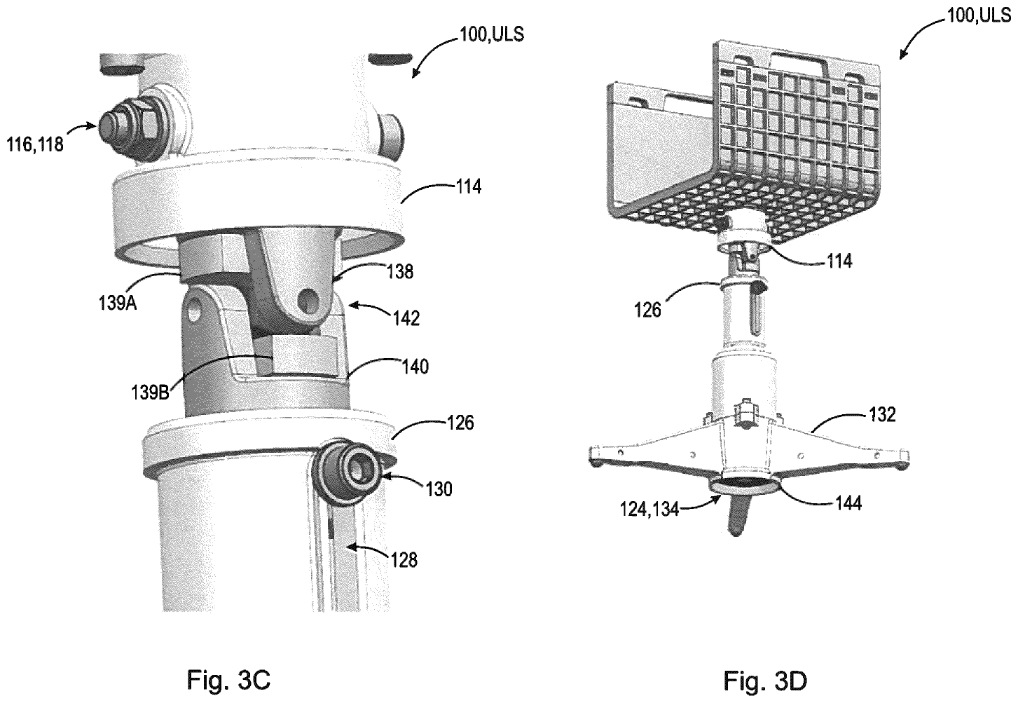

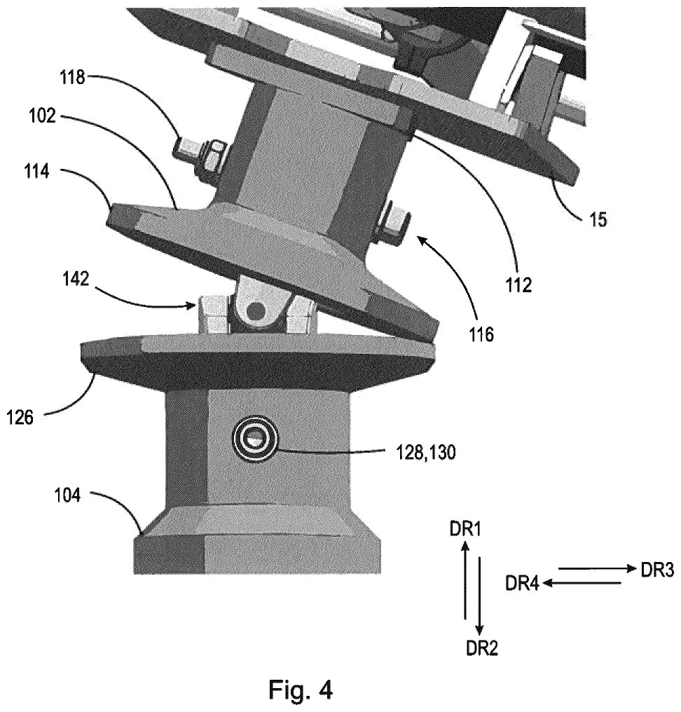

The following description should be read in view of FIGS. 1-7C. As discussed above, lifting mechanism 100 is arranged between UAV 15 and first surface 25 of object 20. In one example, lifting mechanism 100 includes a first housing component 102 and a second housing component 104. First housing component 102 has first end 106 and second end 108. Arranged between first end 106 of first housing component 102 and second end 108 of first housing component 102, is a first through-bore, i.e., first through-bore 110. First end 106 includes engagement plate 112 and second end 108 of first housing component 102 includes first mating flange 114. Engagement plate 112 is fixedly secured to first end 106 of first housing component 102, for example, integrally connected, as illustrated in FIGS. 1-7C. Engagement plate 112 is intended to interface with UAV 15 and/or a plate or interface component secured to UAV 15. As illustrated in FIG. 3D, it should be appreciated that the interface component arranged to interface between engagement plate 112 and UAV 15 can take the form of a basket-type bracket having a recess arranged to receive engagement plate 112. However, it should be appreciated that engagement plate 112 can interface with UAV 15 in a variety of ways, e.g., directly mounting to UAV 15, or engaging with another intermediate bracket assembly. First mating flange 114 is an annular protrusion extending radially outwardly a predetermined distance from the circumferential surface of first housing component 102 and arranged to limit the pivoting and/or rotational motion of the first housing component with respect to the second housing component about first coupling shaft 136, discussed below.

First housing component 102 further includes a first interface aperture 116 arranged to accept a first interface fastener 118. As illustrated in FIGS. 2A-4, first interface aperture 116 is arranged proximate second end 108 of first housing component 102 and is intended to take the form of a vertical, i.e., arranged substantially parallel with first axis A1, slot. Additionally, first interface fastener 118 is intended to be a bolt or other fastener operatively arranged to slidingly engage with first interface aperture 116. It should be appreciated that first interface aperture 116 can take any form capable of allowing for a sliding engagement with first interface fastener 118. First interface fastener 118 is arranged to extend through first interface aperture 116 and engage with first shaft 138 of first coupling shaft 136, discussed below.

Second housing component 104 has third end 120 and fourth end 122. Arranged between third end 120 of second housing component 104 and fourth end 122 of second housing component 104, is a second through-bore, i.e., second through-bore 124. Third end 120 of second housing component 104 includes second mating flange 126. Second mating flange 126 is an annular protrusion extending radially outwardly a predetermined distance from the circumferential surface of second housing component 104 and arranged to limit the pivoting and/or rotational motion of the first housing component 102 with respect to the second housing component 104 about first coupling shaft 136, discussed below.

Second housing component 104 further includes a second interface aperture 128 arranged to accept a second interface fastener 130. As illustrated in FIGS. 2A-4, second interface aperture 128 is arranged proximate third end 120 of second housing component 104. Additionally, second interface fastener 130 is intended to be a bolt or other fastener operatively arranged to fixedly engage with second interface aperture 128. Second interface fastener 130 is arranged to extend through second interface aperture 128 and engage with second shaft 140 of first coupling shaft 136, discussed below.

Furthermore, proximate the fourth end 122, the outer circumferential surface of second housing component 104 is arranged to fixedly secure to a plurality of legs 132. Plurality of legs 132 are arranged to extend radially outward, away from the outer circumferential surface of second housing component and contact first surface 25 of object 20 discussed above. Although illustrated as having three separate legs arranged approximately 120 degrees from each other about the first axis A1, it should be appreciated that more or less than three legs can be utilized, for example, a single stabilizing structure could be used to support lifting mechanism 100 and/or UAV 15 while contacting the ground or first surface 25 of object 20. It should also be appreciated that a plurality of pads may also be provided, at least one on each leg of plurality of legs 132, to soften the contact between the plurality of legs and first surface 25.

Within second through-bore 124 (shown in FIG. 3A) of second housing component 104, and proximate fourth end 122, is a magnet, i.e., magnet 134. Magnet 134, in response to an electric input signal, is arranged to generate a first magnetic field (not shown) proximate fourth end 122 of second housing component 104. Second through-bore 124 may contain a ledge or feature arranged to receive and secure magnet 134 within second housing component and proximate fourth end 122.

Also within second through-bore 124 of second housing component 104, and although not illustrated, various electronic components can be provided. For example, a controller comprising a processor and memory arranged to execute and store, respectively, a set of non-transitory computer readable instructions and a power source, e.g., a battery, may be provided. These electronic components can be directed to interfacing with, e.g., similar electronic components of the UAV, via a wired connection or wireless connection, such that the electrical signal which creates the first magnetic about magnet 134 may be controlled remotely by a user.

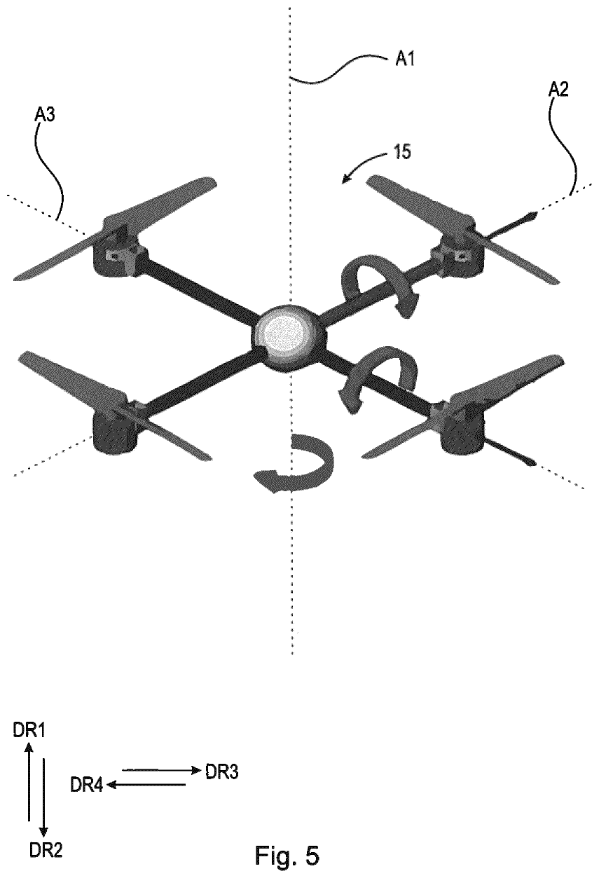

Between first housing component 102 and second housing component 104 is a first coupling shaft, i.e., first coupling shaft 136 (shown in FIG. 2B). First coupling shaft 136 includes first shaft 138 (shown in FIG. 3A), second shaft 140 (shown in FIG. 3A), and first joint 142 (shown in FIG. 3A). First shaft 138 of first coupling shaft 136 is positioned within first through-bore 110 of first housing component 102 and is arranged to receive first interface fastener 118 such that first interface fastener 118 is secured to first shaft 138 and is slidingly engaged within first interface aperture 116. Second shaft 140 of first coupling shaft 136 is positioned within second through-bore 124 of second housing component 104 and is arranged to receive second interface fastener 130 such that second interface fastener 130 is secured to second shaft 140 and second interface aperture 128 located proximate third end 120 of second housing component 104. This arrangement allows first shaft 138 of first coupling shaft 136 to slide within first through-bore 110 of first housing component 102 while second shaft 140 remains fixed to second housing component 104. First Joint 142 is arranged between first shaft 138 and second shaft 140 of first coupling shaft 136. First joint 142 is illustrated as a universal joint or universal hinge; however, it should be appreciated that any joint or connection between first shaft 138 and second shaft 140 which allows for at least two degrees of rotational freedom of the first housing component 102 with respect to the second housing component 104 can be utilized. As will be described below, two degrees of rotational freedom can include rotation about a second axis A2 and a third axis A3 (shown in FIG. 5), where the second axis A2 is arranged parallel to the ground beneath lifting mechanism 100 and orthogonal to first axis A1, and third axis A3 is arranged parallel to the ground beneath lifting mechanism 100 and orthogonal to both first axis A1 and second axis A2.

As illustrated in FIGS. 3C and 3D, first coupling shaft 136 may further include a first resilient material and a second resilient material arranged between first shaft 138 and second shaft 140. First resilient material 139A is integrated within first shaft 138 and arranged to compress and resist compression when first shaft 138 is rotated about second axis A2 and/or third axis A3. Second resilient material 139B is integrated within second shaft 140 and arranged to compress and resist compression when first shaft 138 is rotated about second axis A2 and/or third axis A3. First resilient material 139A and second resilient material 139B are intended to be compressible material, e.g., a rubber body, fixedly secured to first shaft 138 and second shaft 140, respectively. It should be appreciated that first resilient material 139A and second resilient material 139B can be selected from any elastic or deformable material that resists compression that can be affixed to or secured within first coupling shaft 136 such that the rotation of first housing component 102 and second housing component 104 about second axis A2 and third axis A3 is limited or restricted. These resilient materials are intended to provide rotational damping and prevent a resonance between the motion of object 20 beneath UAV 15 during flight.

Lifting mechanism 100 can further include a primary alignment feature 144 (shown in FIGS. 3B and 3D) arranged proximate fourth end 122 of second housing component 104. Primary alignment feature 144 is arranged to removably engage with object alignment feature 30 located on first surface 25 of object 20 as described above. As object alignment feature 30 is intended to take the form of a cylindrical protrusion projecting or extending in a first direction DR1 and having a diameter that is smaller than the diameter of primary alignment feature 144, primary alignment feature 144 can take an inverse shape to that of the object alignment feature 30. For example, primary alignment feature 144 can take the shape of a cylindrical recess extending within a portion of fourth end 122 of second housing component 104 in the first direction DR1, the cylindrical recess having a frustoconical inner circumferential surface which tapers in the first direction DR1 from a first diameter to a second diameter where the first diameter is larger than the second diameter. This frustoconical inner surface of the cylindrical recess, when lowered over the cylindrical protrusion of the object alignment feature operates to receive and center the primary alignment feature 144 about object alignment feature 30 ensuring that lifting mechanism 100 and object 20 are aligned about first axis A1.

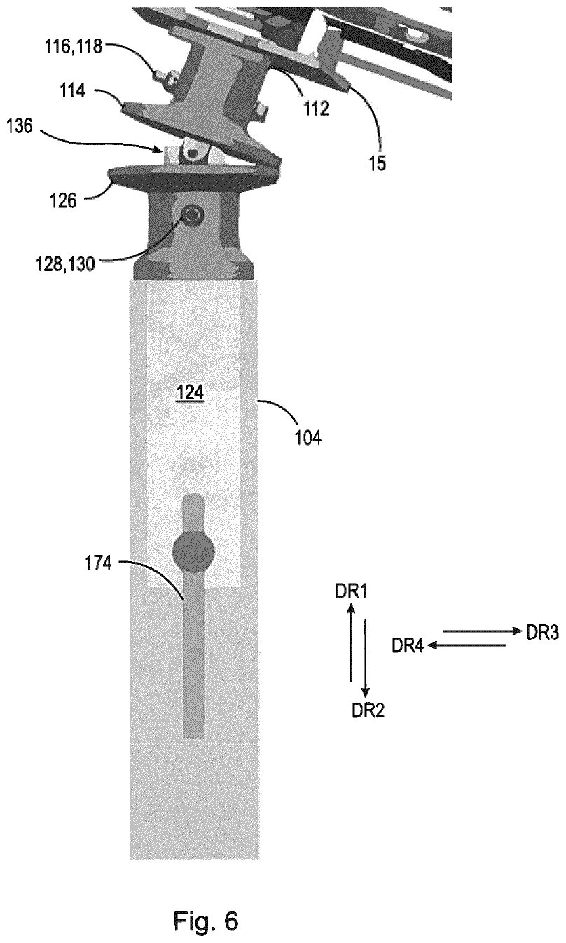

As illustrated in FIG. 6, second housing component 104 can further include a first telescoping slide member 174 engaged with second shaft 140 of first coupling shaft 136. First slide member 174 can be arranged to add an additional margin to the rotational motion in the two degrees of rotational freedom by allowing second shaft 140 and subsequently first coupling shaft 136 to translate within at least second through-bore 124 in the first direction DR1 such that there is additional rotational space between first mating flange 114 and second mating flange 126 or first mating flange 114 and first shaft 138. The translation described above with respect to first coupling shaft 136 and first slide member 174 can be generated when UAV 15 is directed in first direction DR1, e.g., when it takes flight. Although not illustrated, an opposite translation, i.e., a translation of first coupling shaft 136 in a second direction DR2 opposite first direction DR1 can be aided by a first resilient element 148 (not shown), e.g., a spring connected between second shaft 140 and at least a portion of second housing component 104.

During operation of lifting system 10, a user or program may instruct, via a wired or wireless connection with the internal electronic components of UAV 15, UAV to ascend or otherwise move in first direction DR1. As lifting mechanism 100 is fixedly secured to UAV 15 via engagement plate 112 of first housing component 102, lifting mechanism 100 ascends with UAV 15. The user or program directing the UAV 15 may position UAV 15 substantially above, i.e., in the first direction DR1, an object to be lifted, e.g., object 20. The UAV 15 may then descend, i.e., move in the second direction DR2, toward object 20. As UAV 15 approaches first object 20, the primary alignment feature 144 located at fourth end 122 of second housing component 102 is guided onto object alignment feature 30 projecting from first surface 25 of object 20. The frustoconical inner circumferential surface of primary alignment feature 144 described above maintains alignment between lifting mechanism 100 and object 20. Now that UAV 15 is aligned with object 20, UAV 15 may continue to descend until it comes to rest on object 20, i.e., when plurality of legs 132 of second housing component contact first surface 25 of object 20. While at rest, UAV may power down or decrease its propeller speed such that a substantial amount of the UAV's 15 weight is applied to object 20 in second direction DR2. While rested and/or powered-down, lifting mechanism 100 is in a locked state LS, i.e., the weight of UAV 15 causes first mating flange 114 and second mating flange 126 to compress against each other, preventing rotational movement of first housing component 102 with respect to second housing component 104 about first coupling shaft 136.

While UAV is in the locked state LS and in contact with object 20, the electronic components within second housing component 104 of lifting mechanism 100 can be activated, e.g., via a wired or wireless connection with UAV 15, and provide an electrical signal to magnet 134 and create a first magnetic field proximate fourth end 122 and object alignment feature 30. The first magnetic field created will magnetically lock object alignment feature 30 of object 20 to magnet 134 of lifting mechanism 100, coupling the object 20 to the UAV 15.

While the UAV 15 and object 20 are magnetically locked via magnet 134 and object alignment feature 30, the user or program may instruct UAV 15 to ascend once again in first direction DR1. When UAV 15 begins to ascend in first direction DR1, the weight of UAV 15, which was previously compressing first mating flange 114 with second mating flange 126 is no longer compressing the flanges together. Instead UAV 15 begins to pull first housing component 102 in first direction DR1. As first shaft 138 and first interface fastener 118 are arranged to vertically slide within first interface aperture 116, first housing shaft will slide within first interface aperture until first interface fastener 118 makes contact with the first housing component 102, i.e., when the first interface fastener 118 makes contact with the top of the slotted opening. In this state, i.e., the unlocked state ULS, first mating flange 114 and second mating flange 126 are no longer in contact with each other and first joint 142 of first coupling shaft 136 is exposed and arranged to permit rotation of first housing component 102 in two degrees of rotational freedom, i.e., about second axis A2 and third axis A3. In one example, first coupling shaft 136 is arranged to prevent a relative rotation of first housing component 102 and second housing component 104 in a third rotational degree of freedom, i.e., about first axis A1 such that UAV 15 and object 20 may rotate about first axis A1 together.

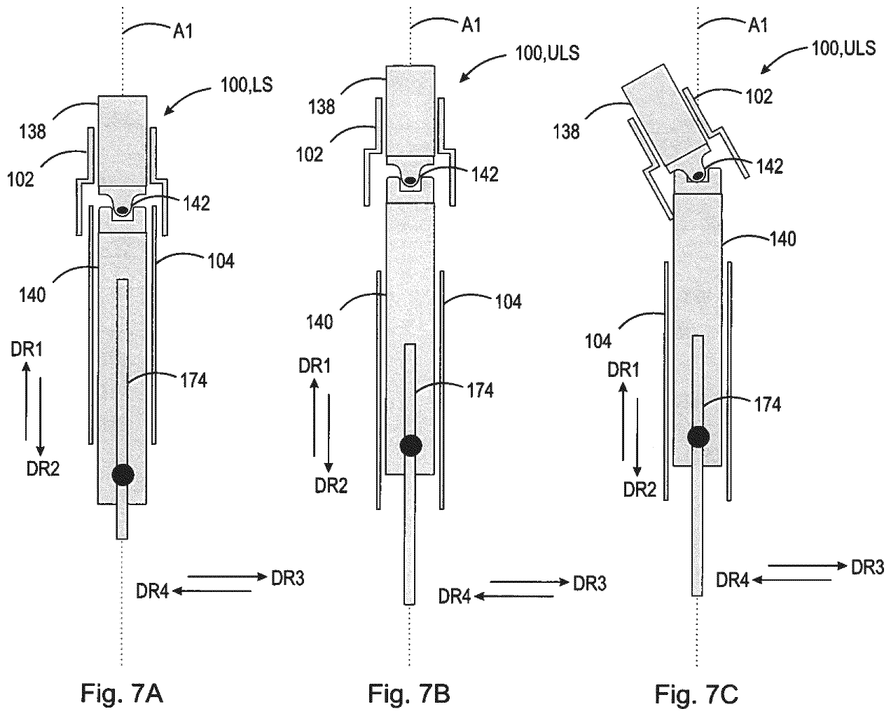

During flight of UAV 15, advantageously, UAV 15 can tilt, i.e., pitch and roll, about second axis A2 and third axis A3, while object 20 remains vertically stable, i.e., positioned substantially beneath UAV 15 along first axis A1, reducing swing caused by the horizontal movement of object 20. As described above, object 20 may be a luminaire or lamp arranged to be installed atop a post, i.e., post 35. If object 20 is a luminaire, for example, the user or program may instruct UAV 15 to navigate to a position directly above post 35 in first direction DR1 as illustrated in FIG. 1. Once in this position, the user or the program may instruct UAV 15 to descend and secure object 20, i.e., a luminaire, to post 35. In one example, as first housing component 102 and second housing component 104 are allowed to rotated with respect to each other with two degrees or rotational freedom but not the third, object 20 and UAV 15 are arranged to rotate together, and, therefore, object 20 may be have be rotationally secured to post 35 via a rotation of UAV 15 about first axis A1. Once secured to post 35, the electronic components within second housing component 104 can send another electrical signal to magnet 134 to depower magnet 134 and remove the magnetic coupling between magnet 134 and object alignment feature 30. UAV 15 is then free to lift another object or land on lifting mechanism 100 which is stabilized by plurality of legs 132. As illustrated in FIGS. 7A-7C, the translation from locked state LS to the unlocked state ULS may be aided by a first slide member 174.

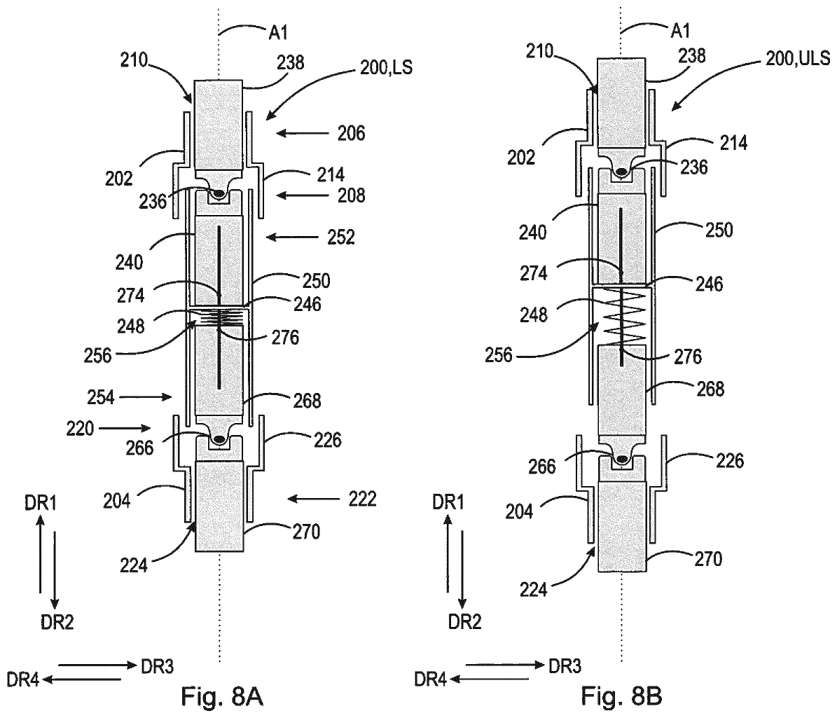

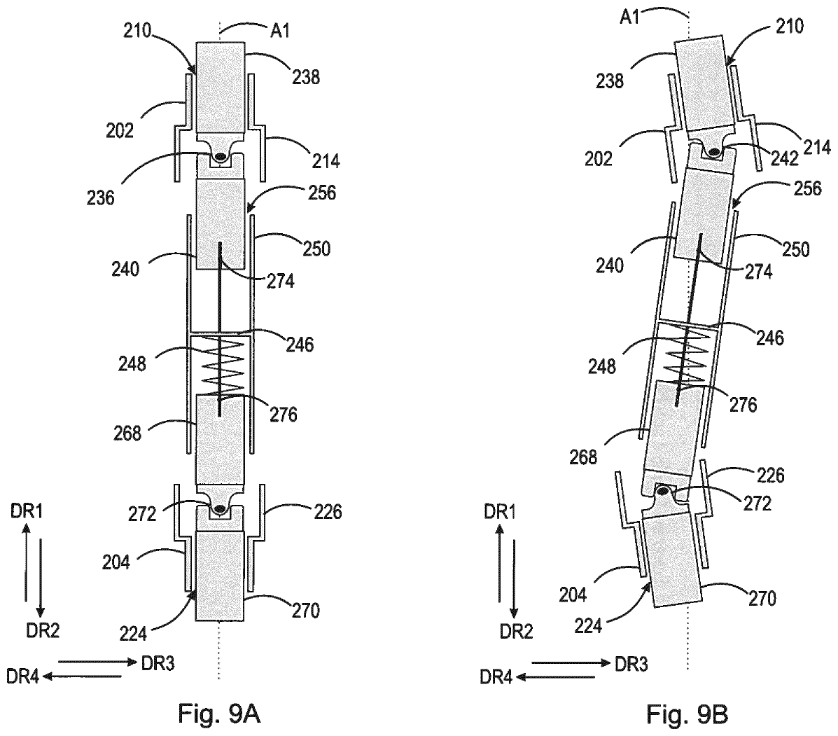

The following description should be read in view of FIGS. 8A-9B. In one example, system 10 includes lifting mechanism 200. Lifting mechanism 200 generally includes a first housing component 202, a second housing component 204, and a third housing component 250. First housing component 202 has first end 206 and second end 208. Arranged between first end 206 of first housing component 202 and second end 208 of first housing component 202, is a first through-bore, i.e., first through-bore 210. First end 206 includes engagement plate 212 (not shown) and second end 208 of first housing component 202 includes first mating flange 214. Engagement plate 212 is fixedly secured to first end 206 of first housing component 202, for example, integrally connected, as illustrated in FIGS. 8A-9B. Engagement plate 212 is intended to interface with UAV 15 and/or a plate or interface component secured to UAV 15. First mating flange 214 is an annular protrusion extending radially outwardly a predetermined distance from the circumferential surface of first housing component 202 and arranged to limit the pivoting and/or rotational motion of the first housing component 202 with respect to the second housing component 204 about first coupling shaft 236, discussed below.

Although, not illustrated, first housing component 202 can further include a first interface aperture 216 arranged to accept a first interface fastener 218. First interface aperture 216 and first interface fastener 218 may be arranged in a substantially similar manner first interface aperture 116 and first interface fasteners 118 as described above with respect to lifting mechanism 100. First interface aperture 216 may be arranged proximate second end 208 of first housing component 202 and can to take the form of a vertical, i.e., arranged substantially parallel with first axis A1, slot. Additionally, first interface fastener 218 may be a bolt or other fastener operatively arranged to slidingly engage with first interface aperture 216. It should be appreciated that first interface aperture 216 can take any form capable of allowing for a sliding engagement with first interface fastener 218. First interface fastener 218 can be arranged to extend through first interface aperture 216 and engage with first shaft 238 of first coupling shaft 236.

Second housing component 204 has third end 220 and fourth end 222. Arranged between third end 220 of second housing component 204 and fourth end 222 of second housing component 204, is a second through-bore, i.e., second through-bore 224. Third end 220 of second housing component 204 includes second mating flange 226. Second mating flange 226 is an annular protrusion extending radially outwardly a predetermined distance from the circumferential surface of second housing component 204 and arranged to limit the pivoting and/or rotational motion of the first housing component 202 with respect to the second housing component 204 about first coupling shaft 236, discussed below.

Although not illustrated, second housing component 204 can further include a second interface aperture 228 arranged to accept a second interface fastener 230. It should be appreciated that second interface aperture 228 and second interface fastener can be substantially similar to second interface aperture 128 and second interface fastener 130 as described above with respect to lifting mechanism 100. Second interface aperture 228 can be arranged proximate third end 220 of second housing component 204. Additionally, second interface fastener 230 can be a bolt or other fastener operatively arranged to slidingly engage with second interface aperture 228. Second interface fastener 230 can also be arranged to extend through second interface aperture 228 and engage with fourth shaft 262 of second coupling shaft 258.

Furthermore, and although not illustrated, proximate the fourth end 222, the outer circumferential surface of second housing component 204 can be arranged to fixedly secure to a plurality of legs 232. It should be appreciated that, although not illustrated for clarity, plurality of legs 232 of lifting mechanism 200 are substantially similar to plurality of legs 132 as described above with respect to lifting mechanism 100.

Within second through-bore 224 of second housing component 204, and proximate fourth end 222, is a magnet, i.e., magnet 234 (not shown for clarity). Magnet 234, in response to an electric input signal, is arranged to generate a first magnetic field (not shown) proximate fourth end 222 of second housing component 204. Second through-bore 224 may contain a ledge or feature arranged to receive and secure magnet 234 within second housing component and proximate fourth end 222.

Also within second through-bore 224 of second housing component 204, and although not illustrated, various electronic components can be provided. For example, a controller comprising a processor and memory arranged to execute and store, respectively, a set of non-transitory computer readable instructions and a power source, e.g., a battery, may be provided. These electronic components can be directed to interfacing with, e.g., similar electronic components of the UAV, via a wired connection or wireless connection, such that the electrical signal which creates the first magnetic about magnet 234 may be controlled remotely by a user.

Arranged between first housing component 202 and second housing component 204 is a third housing component, i.e., third housing component 250. Third housing component 250 includes fifth end 252, sixth end 254, and third through-bore 256 arranged between fifth end 252 and sixth end 254. Although not illustrated, third housing component 250 may further include a third interface aperture 258 arranged to accept a third interface fastener 260 proximate fifth end 252 of third housing component 250. Additionally, third interface fastener may be a bolt or other fastener operatively arranged to fixedly engage with third interface aperture 258. Third interface fastener 260 may be arranged to extend through third interface aperture 258 and engage with second shaft 240 of first coupling shaft 236. Additionally, third housing component 250 may further includes a fourth interface aperture 262 (not shown) arranged to accept a fourth interface fastener 264 (not shown). Fourth interface aperture 262 may be arranged proximate sixth end 254 of third housing component 250. Additionally, fourth interface fastener 264 may be a bolt or other fastener operatively arranged to fixedly engage with fourth interface aperture 262. Fourth interface fastener 264 may also be arranged to extend through fourth interface aperture 262 and fixedly engage with third shaft 268 of second coupling shaft 266 described below. It should be appreciated that, although not illustrated, third interface aperture 258 and further interface aperture 262 are substantially similar to second interface aperture 128 described above with respect to lifting mechanism 100, i.e., are not arranged to slidingly engage with the respective shafts of the first and second coupling shafts. Additionally, it should be appreciated that first interface fastener 260 and fourth interface fastener 264 are substantially similar to second interface fastener 130 as described above with respect to lifting mechanism 100.

As described above, between first housing component 202 and third housing component 250 is a first coupling shaft, i.e., first coupling shaft 236. First coupling shaft 236 includes first shaft 238, second shaft 240, and first joint 242. First shaft 238 of first coupling shaft 236 is positioned within first through-bore 210 of first housing component 202 and is arranged to receive first interface fastener 218 such that first interface fastener 218 is secured to first shaft 238 and is slidingly engaged within first interface aperture 216. Second shaft 240 of first coupling shaft 236 is positioned within third through-bore 256 of third housing component 250 and is arranged to receive third interface fastener 260 such that third interface fastener 260 is secured to second shaft 240 and third interface aperture 258 located proximate fifth end 252 of third housing component 250. This arrangement allows first shaft 238 of first coupling shaft 236 to slide within first through-bore 210 of first housing component 202 while second shaft 240 remains fixed to third housing component 250. First joint 242 is arranged between first shaft 238 and second shaft 240 of first coupling shaft 236. First joint 242 is illustrated as a universal joint or universal hinge; however, it should be appreciated that any joint or connection between first shaft 238 and second shaft 240 which allows for at least two degrees of rotational freedom of the first housing component 202 with respect to the third housing component 250 can be utilized. As will be described below, two degrees of rotational freedom can include rotation about a second axis A2 and a third axis A3, where the second axis A2 is arranged parallel to the ground beneath lifting mechanism 200 and orthogonal to first axis A1, and third axis A3 is arranged parallel to the ground beneath lifting mechanism 200 and orthogonal to both first axis A1 and second axis A2.

Additionally, between third housing component 250 and second housing component 204 is a second coupling shaft, i.e., second coupling shaft 266. Second coupling shaft 266 includes third shaft 268, fourth shaft 270, and second joint 272. Third shaft 268 of second coupling shaft 266 is positioned within third through-bore 256 of third housing component 250 and is arranged to receive fourth interface fastener 264 such that fourth interface fastener 264 is secured to third shaft 268 and is fixedly engaged within fourth interface aperture 262. Fourth shaft 270 of second coupling shaft 266 is positioned within second through-bore 224 of second housing component 204 and is arranged to receive second interface fastener 230 such that second interface fastener 230 is secured to fourth shaft 270 and slidingly engaged with second interface aperture 228 located proximate third end 220 of second housing component 204. This arrangement allows fourth shaft 270 of second coupling shaft 266 to slide within second through-bore 224 of second housing component 204 while third shaft 268 remains fixed to third housing component 250. Second joint 272 is arranged between third shaft 268 and fourth shaft 270 of second coupling shaft 266. Second joint 272 is illustrated as a universal joint or universal hinge; however, it should be appreciated that any joint or connection between third shaft 268 and fourth shaft 270 which allows for at least two degrees of rotational freedom of the third housing component 250 with respect to the second housing component 204 can be utilized. As will be described below, two degrees of rotational freedom can include rotation about a second axis A2 and a third axis A3, where the second axis A2 is arranged parallel to the ground beneath lifting mechanism 200 and orthogonal to first axis A1, and third axis A3 is arranged parallel to the ground beneath lifting mechanism 200 and orthogonal to both first axis A1 and second axis A2.

Although not illustrated, first coupling shaft 236 may further include a first resilient material and a second resilient material arranged between first shaft 238 and second shaft 240. Additionally, second coupling shaft 266 may further include a third resilient material and a fourth resilient material arranged between third shaft 268 and fourth shaft 270. First resilient material 239A (not shown) and third resilient material 239C (not shown) are integrated within first shaft 238 and third shaft 268, respectively, and are arranged to compress and resist compression when first shaft 238 and/or third shaft 268 are rotated about second axis A2 and/or third axis A3. Second resilient material 239B (not shown) and fourth resilient material 239D (not shown) can be integrated within second shaft 240 and fourth shaft 270, respectively, and may be arranged to compress and resist compression when first shaft 238 and fourth shaft 270 are rotated about second axis A2 and/or third axis A3. First resilient material 239A, second resilient material 239B, third resilient material 239C, and fourth resilient material 239D may be a compressible material, e.g., a rubber body, fixedly secured to first shaft 238, second shaft 240, third shaft, 268 and fourth shaft 270, respectively. It should be appreciated that first resilient material 239A and second resilient material 239B can be selected from any elastic or deformable material that resists compression that can be affixed to or secured within first coupling shaft 236 such that the rotation of first housing component 202 and third housing component 250 about second axis A2 and third axis A3 is limited or restricted. Additionally, it should be appreciated that third resilient material 239C and fourth resilient material 239D can be selected from any elastic or deformable material that resists compression that can be affixed to or secured within second coupling shaft 266 such that the rotation of third housing component 250 and second housing component 204 about second axis A2 and third axis A3 is limited or restricted. These resilient materials are intended to provide rotational damping and prevent a resonance between the motion of object 20 beneath UAV 15 during flight.

Lifting mechanism 200 can further include a primary alignment feature 244 (not shown) arranged proximate fourth end 222 of second housing component 204. Primary alignment feature 244 is arranged to removably engage with object alignment feature 30 located on first surface 25 of object 20 as described above. As object alignment feature 30 is intended to take the form of a cylindrical protrusion projecting or extending in a first direction DR1 and having a diameter that is smaller than the diameter of primary alignment feature 244, primary alignment feature 244 can take an inverse shape to that of the object alignment feature 30. For example, primary alignment feature 244 can take the shape of a cylindrical recess extending within a portion of fourth end 222 of second housing component 204 in the first direction DR1, the cylindrical recess having a frustoconical inner circumferential surface which tapers in the first direction DR1 from a first diameter to a second diameter where the first diameter is larger than the second diameter. This frustoconical inner surface of the cylindrical recess, when lowered over the cylindrical protrusion of the object alignment feature operates to receive and center the primary alignment feature 244 about object alignment feature 30 ensuring that lifting mechanism 200 and object 20 are aligned.

Although not illustrated, it should be appreciated that within third housing component, second shaft 240 of first coupling shaft 236 and third shaft 268 of second coupling shaft 266 are arranged to slidingly engage with third through-bore 256. For example, a first and second slide members 274 and 276 (shown in FIGS. 8A-9B) can be secured to second shaft 240 and third shaft 268, respectively, to allow second shaft 240 and third shaft 268 to slide, i.e., translate in the first direction DR1 and the second direction DR2, respectively. The first and second slide members can be arranged to provide an additional margin to the rotational motion in the two degrees of rotational freedom of the first coupling shaft 236 and the second coupling shaft 266 such that there is addition rotational space between, for example, first mating flange 214 and second mating flange 226 or first mating flange 214 and first shaft 238. The translation described above with respect to first coupling shaft 236 and, for example, a first slide member 274 can be generated when UAV 15 is directed in first direction DR1, e.g., when it takes flight.

Within third housing component 250, and within third through-bore 256, there can be a partition 246 and a first resilient element 248. First resilient element 248 is fixedly secured between third shaft 268 of second coupling shaft 266 and partition 246. First resilient element 248 is arranged to provide a force in direction DR2 to third shaft 268. This arrangement, i.e., having a resilient element imparting a force in direction DR2 to second coupling shaft 266 ensures that, when UAV 15 ascends after magnetically coupling to object 20, third shaft 268 telescopes in direction DR2 prior to second shaft 240 telescoping in direction DR1.

During operation of lifting system 10, a user or program may instruct, via a wired or wireless connection with the internal electronic components of UAV 15, UAV to ascend or otherwise move in first direction DR1. As lifting mechanism 200 is fixedly secured to UAV 15 via engagement plate 212 (not shown) of first housing component 202, lifting mechanism 200 ascends with UAV 15. The user or program directing the UAV 15 may position UAV 15 substantially above, i.e., in the first direction DR1, an object to be lifted, e.g., object 20. The UAV 15 may then descend, i.e., move in the second direction DR2, toward object 20. As UAV 15 approaches first object 20, the primary alignment feature 244 (not shown) located at fourth end 222 of second housing component 202 is guided onto object alignment feature 30 projecting from first surface 25 of object 20. The frustoconical inner circumferential surface of primary alignment feature 244 described above maintains alignment between lifting mechanism 200 and object 20. Now that UAV 15 is aligned with object 20, UAV 15 may continue to descend until it comes to rest on object 20, i.e., when plurality of legs 232 of second housing component contact first surface 25 of object 20. While at rest, UAV may power down or decrease its propeller speed such that a substantial amount of the UAV's 15 weight is applied to object 20 in second direction DR2. While rested and/or powered-down, lifting mechanism is in a locked state LS (shown in FIG. 8A), i.e., the weight of UAV 15 causes first mating flange 214 of first housing component 202 and fifth end 252 of third housing component 250 to compress toward each other (shown in FIG. 8A) and sixth end 254 of third housing component 250 and second mating flange 226 of second housing component 204 to compress toward each other (shown in FIG. 8A), preventing rotational movement of first housing component 202 with respect to third housing component 250 and rotation movement of the third housing component 250 with respect to second housing component 204. These compression forces in second direction DR2 also compress first resilient element 248 to compress against partition 246 (as illustrated in FIG. 8A).

While UAV is in the locked state LS and at rest or powered down and in contact with object 20 (e.g., as shown in FIG. 8A), the electronic components within second housing component 204 of lifting mechanism 200 can be activated, e.g., via a wired or wireless connection with UAV 15, and provide an electrical signal to magnet 234 and create a first magnetic field proximate fourth end 222 and object alignment feature 30. The first magnetic field created will magnetically lock object alignment feature 30 of object 20 to magnet 234 of lifting mechanism 200, coupling the object 20 to the UAV 15.

While the UAV 15 and object 20 are magnetically locked via magnet 234 and object alignment feature 30, the user or program may instruct UAV 15 to ascend once again in first direction DR1. When UAV 15 begins to ascend in first direction DR1, the weight of UAV 15, which was previously compressing first mating flange 214 in the direction of fifth end 252 of third housing component 250 and sixth end 254 of third housing component 250 toward second mating flange 226 of second housing component 204 is released. As UAV 15 begins to pull first housing component 102 in first direction DR1 UAV 15 may experience motion in a third direction DR3 or a fourth direction DR4, i.e., a direction orthogonal to first direction DR1 and second direction DR2. This horizontal motion may happen as the lift force produced by the wings becomes substantially equal to the weight of UAV 15. While these two forces are substantially equal, any outside force, e.g., forces caused by winds or small imbalances in the orientation of UAV 15, can cause UAV 15 to translate in, e.g., third direction DR3. First resilient element 248 is arranged to provide a force in second direction DR2 such that third shaft 268 of second coupling shaft 266 telescopes before any corresponding telescoping translation of second shaft 240 of first coupling shaft 236 within third housing component 250. Due to the force of first resilient element 248 in direction DR2 on third shaft 268, second coupling shaft 266 is unlocked prior to first coupling shaft 236. This allows for a side to side, i.e., horizontal translation of UAV 15 while allowing object 20 to remain level.

Subsequently, first shaft 238 and/or second shaft 240 can translate within first housing component 202 and/or third housing component 250, as described above. In this state, i.e., the unlocked state ULS (shown in FIGS. 8B-9B), first mating flange 214 and third housing component 250 as well as second mating flange 226 and third housing component are no longer in contact with each other and first joint 142 of first coupling shaft 136 and second joint 272 of second coupling shaft 266 are exposed and arranged to permit rotation of first housing component 202 in two degrees of rotational freedom, i.e., about second axis A2 and third axis A3, and permit rotation of third housing component 250 in two degrees of rotational freedom. In one example, first coupling shaft 236 and second coupling shaft 266 are arranged to prevent rotation in a third rotational degree of freedom, i.e., about first axis A1 such that UAV 15 and object 20 may rotate about first axis A1 together.

During flight of UAV 15, advantageously, UAV 15 can tilt, i.e., pitch and roll, about second axis A2 and third axis A3, while object 20 remains vertically stable, i.e., positioned substantially beneath UAV 15 along first axis A1, reducing swing caused by the horizontal movement of object 20. As described above, object 20 may be a luminaire or lamp arranged to be installed atop a post, i.e., post 35. If object 20 is a luminaire, for example, the user or program may instruct UAV 15 to navigate to a position directly above post 35 in first direction DR1 as illustrated in FIG. 1. Once in this position, the user or the program may instruct UAV 15 to descend and secure object 20, i.e., a luminaire, to post 35. In one example, as first housing component 202 and third housing component 250, as well as, third housing component 250 and second housing component 204 are allowed to rotated with respect to each other with two degrees or rotational freedom but not the third, object 20 and UAV 15 are arranged to rotate together, and, therefore, object 20 may be have be rotationally secured to post 35 via a rotation of UAV 15 about first axis A1. Once secured to post 35, the electronic components within second housing component 104 can send another electrical signal to magnet 234 to depower magnet 234 and remove the magnetic coupling between magnet 234 and object alignment feature 30. UAV 15 is then free to lift another object or land on lifting mechanism 200 which is stabilized by plurality of legs 232.

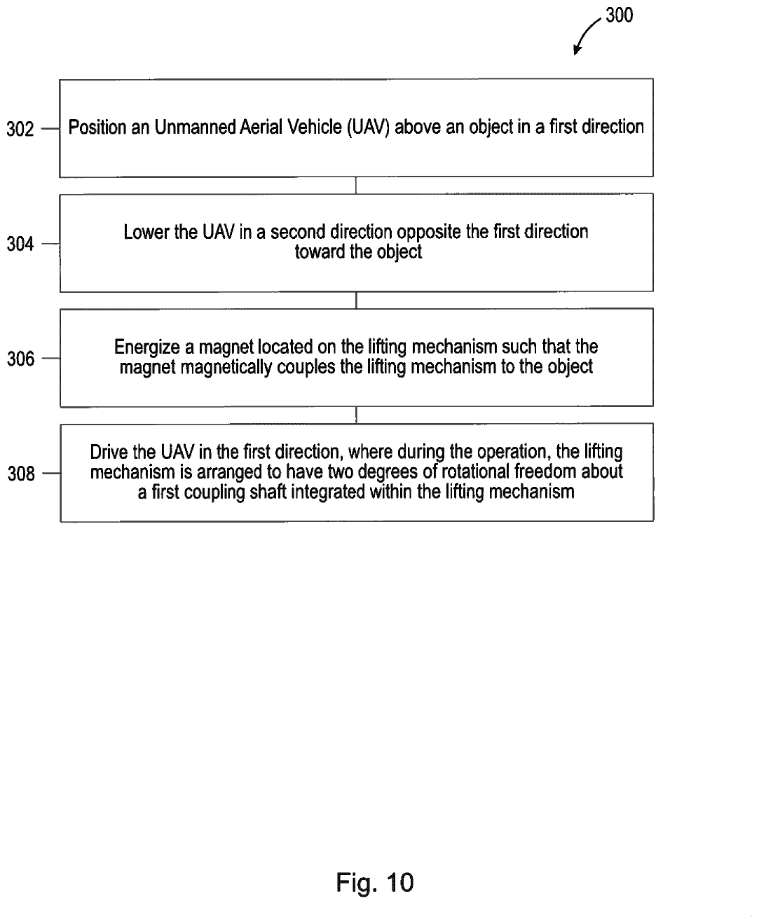

As illustrated in FIG. 10, provided herein is a method for coupling a lifting mechanism (100, 200) to a UAV 15, i.e., method 300. Method 300 can include, for example: positioning the UAV 15 above an object 20 in a first direction DR1 (step 302); lowering the UAV 15 in a second direction opposite DR2 the first direction DR1 toward the object 20 (step 304); energizing a magnet (134, 234) located on the lifting mechanism (100, 200) such that the magnet (134, 234) magnetically couples the lifting mechanism (100, 200) to the object 20 (step 306); driving the UAV 15 in the first direction DR1, where during operation the lifting mechanism (100, 200) is arranged to have two degrees of rotational freedom about a first coupling shaft (136, 236) integrated within the lifting mechanism (100, 200) (step 308). As described above with respect to the operation of lifting mechanisms 100 and 200, during the operation of the lifting mechanism, the lifting mechanism is arranged to transition from a locked state to an unlocked state, where the lifting mechanism is in the unlocked state during a first motion of the UAV.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A lifting mechanisms comprising:
a first housing component;
a second housing component comprising:
a plurality of legs arranged to stabilize the lifting mechanism against a surface of an object; and,
a magnet arranged within the second housing component; and,
a first coupling shaft arranged between the first housing component and the second housing component the first coupling shaft arranged to allow for two degrees of rotational freedom of the first housing component with respect to the second housing component,
wherein the first housing component further comprises a first end, a second end, and a first through-bore arranged between the first end and the second end;
the second housing component further comprises a third end, a fourth end, and a second through-bore arranged between the third end and the fourth end; and
wherein the first coupling shaft includes a first shaft and a second shaft coupled via a first joint and the first shaft is positioned within the first through-bore.

2. (canceled)

3. The lifting mechanism of claim 1, wherein the first housing component further comprises a first interface aperture arranged to accept a first interface fastener, the first interface fastener arranged to engage with the first shaft of the first coupling shaft and slidingly engage with the first interface aperture.

4. The lifting mechanism of claim 1, wherein the second housing component further comprises a second interface aperture arranged proximate the third end of the second housing component and arranged to receive a second interface fastener, the second interface fastener arranged to fixedly secure the second housing component to the second shaft of the first coupling shaft.

5. The lifting mechanism of claim 1, wherein the fourth end of the second housing component comprises a primary alignment feature arranged to engage with an object alignment feature on the object.

6. The lifting mechanism of claim 1, further comprising a first slide member arranged within the second through-bore and operatively engaged with the second shaft of the first coupling shaft.

7. The lifting mechanism of claim 1 further comprising:
a third housing component comprising:
a fifth end;
a sixth end;
a third through-bore arranged between the fifth end and the sixth end;
a second coupling shaft arranged between the first housing component and the second housing component and arranged to allow arranged to allow for two degrees of rotational freedom of the first housing component with respect to the third housing component, where the second coupling shaft further comprises a third shaft, a fourth shaft, and a second joint.

8. The lifting mechanism of claim 7, wherein the first housing component further comprises a first interface aperture arranged to accept a first interface fastener, the first interface fastener arranged to engage with the first shaft of the coupling shaft and slidingly engage with the first interface aperture;
the third housing component further comprises a second interface aperture arranged proximate the fifth end of the third housing component and arranged to receive a second interface fastener, the second interface fastener arranged to fixedly secure the third housing component to the second shaft of the first coupling shaft.

9. The lifting mechanism of claim 8, wherein the third housing component further comprises a third interface aperture arranged to accept a third interface fastener, the third interface fastener arranged to engage with the third shaft of the second coupling shaft and fixedly secure the sixth end of the third housing component to the third shaft of the second coupling shaft; and,
wherein the second housing component further comprises a fourth interface aperture arranged to accept a fourth interface fastener, the fourth interface fastener arranged to engage with the fourth shaft of the second coupling shaft and fixedly secure the third end of the second housing component to the fourth shaft of the second coupling shaft.

10. The lifting mechanism of claim 7, further comprising:
a first slide member arranged within the third through-bore and operatively engaged with the second shaft of the first coupling shaft; and,
a second slide member arranged within the third through-bore and operatively arranged to engage with the third shaft of the second coupling shaft.

11. The lifting mechanism of claim 7, wherein the third through-bore of the third housing component further includes a first partition, wherein the first partition is secured to the third shaft of the second coupling shaft via a first resilient element.

12. The lifting mechanism of claim 1, wherein the first end of the first housing component comprises a first engagement plate arranged to fixedly secure the first housing component to an Unmanned Aerial Vehicle (UAV).

13. A method of lifting an object using an Unmanned Aerial Vehicle (UAV), the method comprising:
coupling a lifting mechanism to a UAV;
positioning the UAV above an object in a first direction;
lowering the UAV in a second direction opposite the first direction toward the object;
energizing a magnet located on the lifting mechanism such that the magnet magnetically couples the lifting mechanism to the object;
driving the UAV in the first direction, where during operation the lifting mechanism is arranged to have two degrees of rotational freedom about a first coupling shaft integrated within the lifting mechanism,
wherein the first coupling shaft is arranged between a first housing component of the lifting mechanism and a second housing component of the lifting mechanism, the first coupling shaft arranged to allow for the two degrees of rotational freedom of the first housing component with respect to the second housing component,
wherein the first housing component further comprises a first end, a second end, and a first through-bore arranged between the first end and the second end;
the second housing component further comprises a third end, a fourth end, and a second through-bore arranged between the third end and the fourth end;
wherein the first coupling shaft includes a first shaft and a second shaft coupled via a first joint and the first shaft is positioned within the first through-bore.

14. The method of claim 13, further wherein during the operation of the lifting mechanism the lifting mechanism is arranged to transition from a locked position to an unlocked position, where the lifting mechanism is in the unlocked position during a first motion of the UAV.
